(19) United States
(12) Patent Application Publication
(10) Pub. No.: US 2009/0182682 A1
(43) Pub. Date: Jul. 16, 2009

(54) Bank-eligible investment product and a system and method for designing, implementing, monitoring and managing the same

(75) Inventors: Warren T. Wamberg, North Barrington, IL (US); Charles French, Chicago, IL (US); Ryan Ball, Chicago, IL (US)

Correspondence Address: DICKSTEIN SHAPIRO LLP, 1825 EYE STREET NW, Washington, DC, 20006-5403, US

(73) Assignee: WAMBERG ASSET MANAGEMENT LLC

(21) Appl. No.: 12/007,557

(22) Filed: Jan. 11, 2008

(51) Int. Cl. G06Q 40/00

(52) U.S. Cl. 705/36 R

(57) ABSTRACT

A computer system and computative process for designing, implementing, processing, communicating and managing a bank-eligible investment product that invests in other bank-eligible investments wherein the risk-based capital exposure of each investment is compared to a limit database and processed using a plurality of risk-weight percentages stored in the database. The computer system receives as its inputs performance data and asset allocation data for each investment and processes that data in order to calculate the risk-based capital exposure of each investment inside the product, determine the risk-based capital assessment of an investor's total investment in the product, and as part of its output, provides sufficient reporting information for investors as required by federal, state, and local regulations. In one embodiment, the constraints of each investment inside the product are frequently and periodically reprocessed, according to prescribed system parameters in order to achieve desired risk-based capital output for communication to users and for adjustment of the composition of the bank-eligible investment product.

### FIELD OF THE INVENTION

The present invention relates to a system and method for designing, implementing, monitoring, and managing bank-eligible investments in compliance with federal, state and local regulations governing risk-based capital allocation. The present invention also covers a bank-eligible investment product comprised of a multiple manager, multiple strategy hedge fund system, or alternatively, a collection of investments in other bank-eligible investments, e.g., collateralized debt obligations (CDOs), mortgage-backed securities, treasury bonds, municipal bonds, equities, and mutual funds, and a system for designing, implementing, monitoring, communicating, processing and managing such an investment product to minimize risk-based capital exposure.

### BACKGROUND OF THE INVENTION

Recently, private equity and hedge fund investments have taken center stage in the investment community. Such investment vehicles often use proprietary strategies to achieve an absolute return relative to the greater investment market. Banks desire such absolute returns, but are subject to stringent and extensively regulated requirements for both capital—codified in 12 C.F.R. 3 (the “Code”) and investment-codified in section 24 (Seventh) of the National Bank Act (the “Act”) and the rules, regulations, and interpretive guidance promulgated by the OCC and published in Part 1 of Title 12 of the Code of Federal Regulations (such investments are referred to, collectively, hereinafter as “Bank Eligible Investments”). This regulatory scheme is designed to ensure the safety and soundness of banks and to therefore mitigate the risks to taxpayers and deposit-holders in the event that a bank becomes insolvent. In this regulatory scheme, a bank cannot engage in an activity that is not explicitly or implicitly authorized by statute, regulation, or precedent.

As outlined in the guidelines provided in Appendix A to the Code, a bank's risk-based capital ratio is obtained by dividing its capital base by its risk-weighted assets. According to the Code, investments are classified into four categories: riskless, low-risk, medium-risk, and high-risk, and are assigned a risk-weight of 0%, 20%, 50%, or 100%, respectively. The amount of each bank's risk-weighted assets is calculated by adding together the capital value of each asset multiplied by its risk category percentage.

For a bank to be considered ‘well-capitalized’ under the Code, the ratio of its capital to its risk-weighted assets must be sufficiently low. Specifically, a bank must maintain a minimum ratio of capital base to risk-weighted assets of 10%, with core, or “Tier 1” capital representing at least 6%. Additionally, banks must also have and maintain a total assets leverage ratio of “Tier 1” capital in an amount equal to at least 5 percent of adjusted total assets. Banks are required to file reports on a regular basis with the Office of the Comptroller of the Currency (“OCC”). Thus, the risk-weighting and total risk-based capital exposure of an investment is a required function that all banks must maintain, monitor, and report in order to comply with the Code.

Under 12 C.F.R. 1.3(h), a national bank may purchase for its own account shares in an investment company, provided the investment company has a portfolio consisting entirely of bank-eligible investment securities. National banks must conduct an independent review of the investment company's holdings to determine whether its portfolio does indeed consist of bank-eligible investment securities and to determine applicable legal investment limitations under 12 U.S.C. 24 (Seventh) and 12 C.F.R. 1. The aggregate par value of investment securities held by the bank issued by any one obligor may not exceed 10 percent of the bank's capital and surplus.

A bank may risk-weight its total investment in an investment company in the risk category appropriate to the highest risk-weighted asset the company's portfolio holds, consistent with the investment limits the company incorporates into its prospectus. Alternatively, banks may assign investment company share investments to different risk categories on a pro rata basis according to the investment limits in the company's prospectus. That banks may do so provides important justification for the present invention. Regardless of the risk-weighting method used, however, the minimum risk-weight that may be assigned to investment company shares is 20 percent—as an investment company has certain credit, transaction, and compliance risks that necessitate a risk-weight greater then zero percent. Furthermore, if the bank assigns investment company assets to risk categories on a pro rata basis, and the sum of the investment limits in the investment company's prospectus exceeds 100 percent, the bank must assign the highest pro rata amounts of its total investment to the highest risk categories.

In OCC Interpretive Letter #912, the OCC stated that an investment product which is composed of multiple other investments may obtain a total risk-based capital exposure calculation by aggregating the risk-based capital exposure of each of its multiple investments. However, to obtain this treatment, individual investments must be constrained (by contract or otherwise) to invest no more than a certain amount of capital in each risk-weighted category. Thus, it is necessary to consider performance and asset allocation data for each individual investment to select risk-weight constraints for the sub-parts of those investments and calculate each investment's total risk-based capital exposure, before aggregating the risk-based capital exposure of each investment to obtain the total risk-based capital exposure of the entire investment product. Further, there exists a need to monitor the performance and asset allocation data of these individual investments and their requisite subparts so that risk-weight constraints can be adjusted on a periodical basis.

A national bank's board of directors has the ultimate responsibility for deciding whether to invest in an investment company but once that decision is made, the bank's board must review those holdings to determine whether a particular company's shares continue to be appropriate for the bank's investment portfolio. Additionally, though the OCC currently takes the position that it is more prudent to base risk-weight distributions on investment limits rather than on a investment company's actual underlying assets because actual portfolio holdings can change significantly from day to day. New systems and analytical/processing methods are needed in order to provide an ability for maintaining real-time risk-weight distributions of underlying assets. This provides motivation to monitor performance and asset allocation data associated with each investment in real-time.

In sum, there exists a need for a bank-eligible investment technology product as well as a computer-based system and related methodologies for designing, processing, implementing, monitoring, communicating, and managing bank-eligible investments which determines the risk-based capital exposure of multiple assets. Additionally a system and methodology is required that communicates and transmits, as part of its overall system output, reporting information for investors in compliance with changing federal, state, and local laws. Compared with bank-eligible investment products known in the art, the embodiments of the present invention provide improved liquidity, increased transparency, and improved risk-reduction. There is a further need for an investment system which controls and manages the investments in order to minimize total risk-based capital exposure by adjusting capital constraints to individual investments based on risk-based capital exposure performance and allocation data.

### BRIEF SUMMARY OF THE INVENTION

The present invention comprises a computer system and computative process for designing, implementing, processing, communicating and managing a bank-eligible investment product that invests in other bank-eligible investments wherein the risk-based capital exposure of each investment is compared to a limit database and processed using a plurality of risk-weight percentages stored in the database. The computer system receives as its inputs performance data and asset allocation data for each investment and processes that data in order to calculate the risk-based capital exposure of each investment inside the product, determine the risk-based capital assessment of an investor's total investment in the product, and as part of its output, provides sufficient reporting information for investors as required by federal, state, and local regulations. In one embodiment, the constraints of each investment inside the product are frequently and periodically reprocessed, according to prescribed system parameters in order to achieve desired risk-based capital output for communication to users and for adjustment of the composition of the bank-eligible investment product.

The present system is also adapted to select from a plurality of investment management decision engines to manage capital inside the bank-eligible portfolio. Each process employs a differing investment strategy. This multi-process structure allows for new strategies for investment to be quickly introduced and does not limit the system to the present universe of known investment strategies. By using external investment management decision engines connected to the present system and automatically monitoring them, the present system can be constructed without resorting to the expense of developing internal resources for investment management. Another aspect of the present invention is in using the external processes to direct the system to acquire and manage assets but not ceding actual control of the assets, as a consequence, the present system protects the investment product from certain risks with respect to asset value (e.g., redemptions) that can result from ceding capital to co-mingled investment entities (i.e. mutual funds in a fund of funds context). Further, the present system optionally contains an administrative component that is adapted to analyze positions and perform stress-testing.

### BRIEF DESCRIPTION OF THE DRAWINGS

The advantages and features of the invention will be understood from the detailed description provided below with reference to the accompanying drawings.

FIG. 1 depicts the structure of the present invention

FIG. 2 depicts the process by which the present invention identifies, selects and acquires the assets which comprise a bank-eligible investment product.

FIG. 3 depicts an exemplary asset eligibility screening process.

FIG. 4 depicts an exemplary asset monitoring process.

FIG. 5 depicts an exemplary asset reallocation process.

FIG. 6 depicts an exemplary composition of an investment product asset portfolio created by the present invention.

FIG. 7 depicts a computer hardware diagram corresponding to the structure of the present invention.

### DETAILED DESCRIPTION OF THE INVENTION

In the following detailed description, reference is made to various specific embodiments of the invention. These embodiments are described with sufficient detail to enable those skilled in the art to practice the invention. It is to be understood that other embodiments may be employed, and that various structural and logical changes may be made without departing from the spirit or scope of the invention.

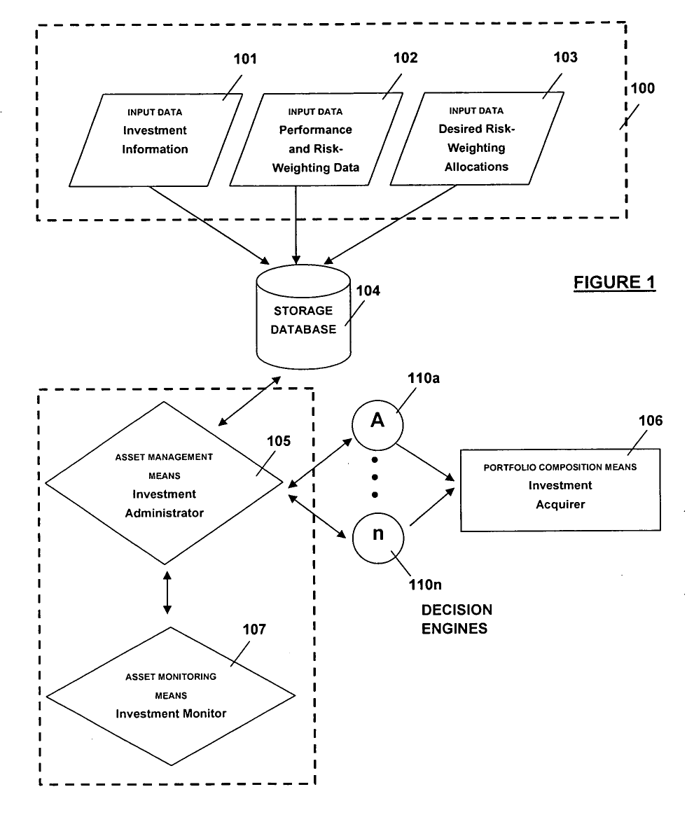

One of the preferred embodiments is depicted in FIG. 1. The input unit of the present invention is organized into process or apparatus 100, which can be implemented in any number of known formats (e.g., terminal input, Windows program, HTTP based web form, communications link(s)). Input source 101 collects investment information from commercial databases or other sources of available investment information/products consisting of structure, area of market concentration, manager's qualifications, and other pertinent data. Such investments may or may not trade on public markets.

The manner in which such information is collected and received varies, but can include Internet web bots, data streams, electronic ticker feeds, RSS feeds, e-mail, fax, disks, or any other known or conventional means of information delivery. Input source 102 collects historical performance data for the investments collected by input source 101, as well as, if any, data on the risk-based capital weighting of each collected investment. The data for source 102 can be derived from any conventionally known source. Input source 103 collects from the user any necessary information to compose the portfolio, such as amount of capital, number of assets to select, and desired risk-weight.

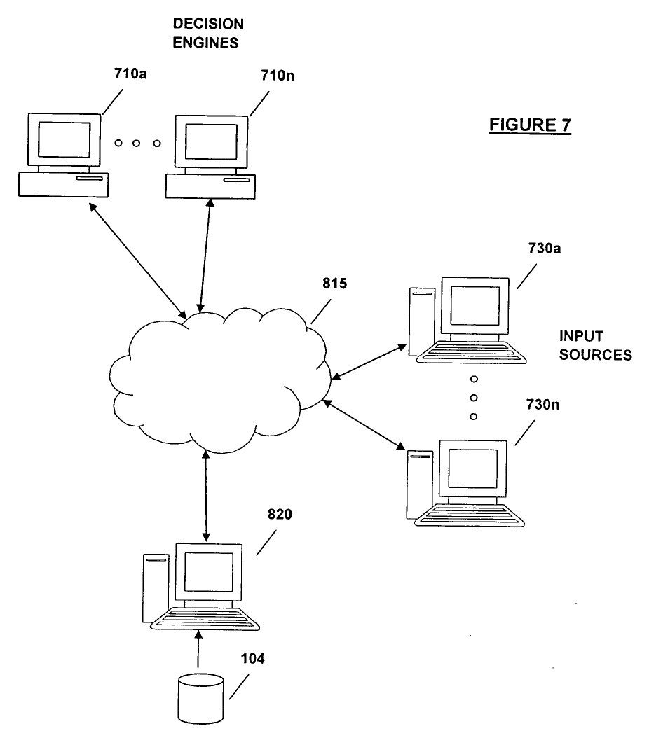

FIG. 7 illustrates a computer hardware and network diagram showing an exemplary embodiment of a hardware system through device/process 100 operates. In this environment, the device/process 100 is embodied as computer software running on computer systems. Computer systems 710(a-n) run investment management decision engines 110(a-n) embodied as computer software. Computer systems 730(a-n) communicate with server 820 and are data sources for input process or apparatus 100 embodied as computer software running on server 820.

The data collected by input process 100 is stored in a storage database 104. Such database could be a Microsoft SQL or MySQL database running on a UNIX or Windows platform. The system additionally includes investment management decision engines 110(a-n), an asset management module or apparatus 105, a composition unit 106, and a asset monitoring module or apparatus 107. Asset management module or apparatus 105 and asset monitoring module or apparatus 107 can be embodied in the same module or apparatus. As shown in FIG. 7, storage database 104 is run on server 820.

Management module or apparatus 105 manages the data stored in database 104, accounting for, among other things, the constraints input by the user to input source 103. Decision engines 110a-n identify assets for which the system is to allocate capital to through composition means 106. Management module or apparatus 105 can be embodied as computer software running on server 820. Composition unit 106 receives the data output by the management module or apparatus 105 and acquires the assets in allocations (determined by decision engines 110a-n). Composition unit 106 can also be embodied as computer software running on server 820. Investment monitoring unit 107 performs analysis and display functions and additionally optionally identifies underperforming assets and replaces them by instructing decision engines 110a-n to choose new assets. Investment monitoring unit 107 can be embodied as computer software running on server 820.

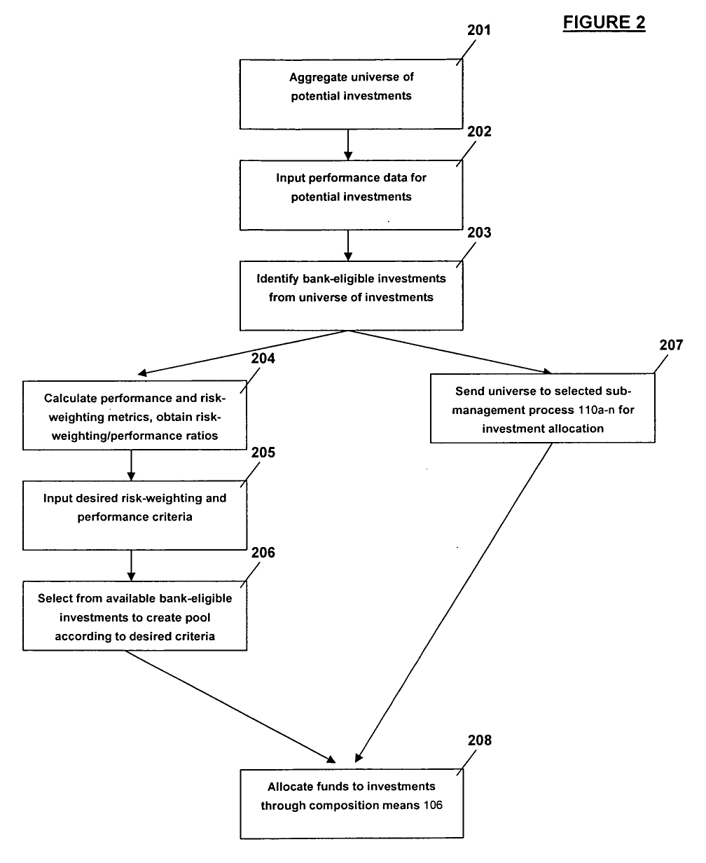

FIG. 2 is an exemplary illustration of the process by which the system manages bank-eligible assets, approximately represented by management module or apparatus 105 and composition unit 106 on FIG. 1. FIG. 2 shows both internal and external selection embodiments by which the system can operate to identify which assets to allocate capital.

Generally, the system, operating through its users, enables the management module or apparatus 105 to transparently ensure that the plurality of assets selected by decision engines 110a-n are bank-eligible and fully compliant. Composition unit 106 then acquires these assets. Alternatively, in a second embodiment, the system manages itself by choosing from among available bank-eligible investments and comparing them based on historical investment data as correlated to risk-based capital category. In this second embodiment the system then selects those potential investments that have performed historically better in their risk-based capital categories and allocates capital to meet a desired risk-based capital allocation for the bank-eligible investment product.

In step 201, the system aggregates the universe of potential bank-eligible investments. Specifically, it reviews data received through input process 100 and unit 101 to ensure entries for investments are complete and populated with sufficient data to be analyzed. Alternatively, if the system is configured to receive a complete set of data with respect to potential assets, the system moves directly to step 202 to review and analyze positions received through input process 100. Next, in step 202, the system retrieves historical performance data for all the investments through input unit 102. Next, in step 203, the system reviews each of the potential assets to determine whether they are bank-eligible. This step allows the system to analyze potential assets for compliance purposes.

In a first embodiment, the system provides the results obtained in step 203 to the decision engines 110a-n in step 207, which then select a plurality of bank-eligible investments to allocate capital. The system selects from among a plurality of decision engines 110a-n each of which can be embodied as computer software routines or programs running on a plurality of computer systems connected through the internet or other communication means to primary server 820. Each of these engines obeys different investment strategies with respect to assets. In one such example of a potential investment strategy, the decision engines may prefer assets comprised of mortgage-backed securities having certain desired characteristics. Such desired characteristics could include a decreased likelihood of prepayment due to state-mandated pre-payment taxation, or low local default rates. In another example, the investment management decision engines may prefer assets composed of mortgage-backed securities that have low-loan balances. In a third example, investment management decision engines may prefer assets composed of treasury or municipal instruments with spreads above or below a particular moving average. An example of such software that can be adapted to perform the functions of an exemplary decision engine 110a-n is the PerTrac Analytical Platform. Steps 204-206 are not performed in the first embodiment because the external decision engines invoked in step 207 do their own analysis of the bank-eligible investments.

The decision engines 110a-n can also be adapted to continuously modify the composition of the plurality of bank-eligible investments selected and instruct the composition unit 106 to acquire or sell positions in those investments. This allows the decision engines to contain separate logic to maximize return on the investments they selects.

In a second embodiment, the system takes each bank-eligible investment identified in step 203 and calculates measurement metrics (e.g., Sharpe and Appraisal ratio) in step 204. In step 205, the system receives input data relating to the risk-weighting and desired performance input by the user through input process 100 and input unit 103. Using that data, in step 206 the system pools bank-eligible investments by desired criteria (e.g., size, breadth of positions, market concentration, specialization). From the pools identified by step 206, the system (instead of using decision engines 110a-n) selects from those pools investments selected having the highest risk-weighting to performance ratio. Selection by highest risk-weighting to performance ratio is the default function, but other criteria for selection can be specified, such as lowest investment churn ratio or other metrics known in the field.

Finally, in both embodiments, once the system has either selected bank-eligible investments or received them from the decision engines in step 207, in step 208, the system uses composition means 106 to acquire positions in each of the bank-eligible investments, such positions being weighted to obtain the desired risk-based capital level for the bank-eligible investment product. Means 106 can be any conventionally known device such as a computer, logic unit, network, PDA or appropriate software routine or engine known in the art.

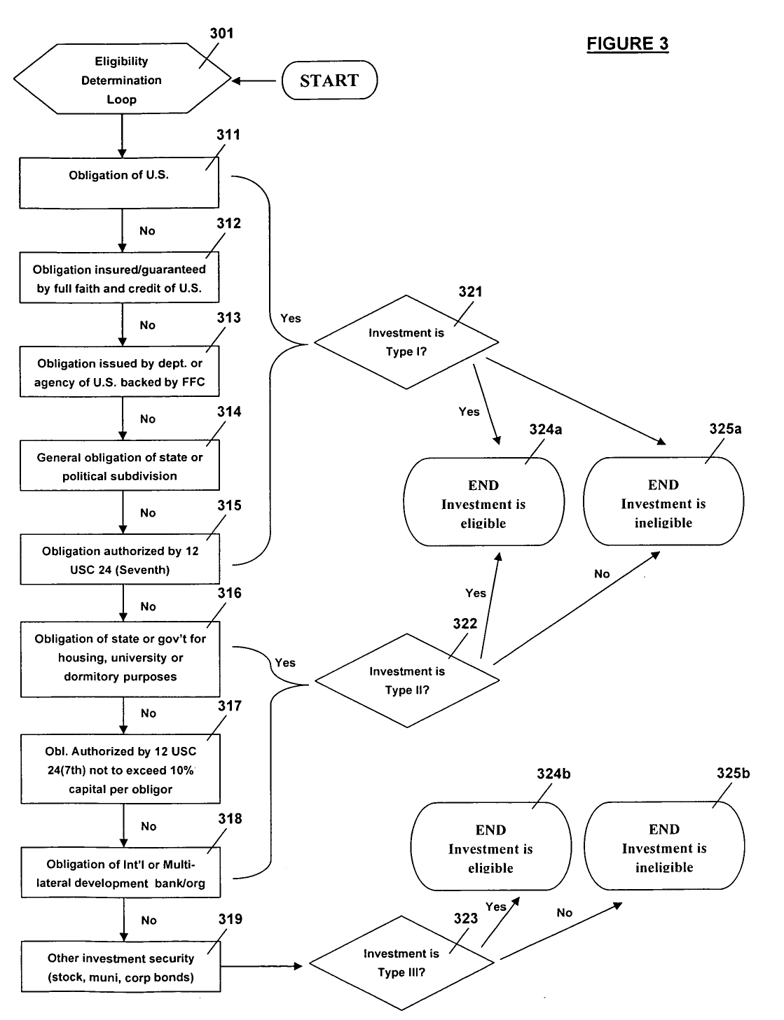

FIG. 3 depicts an exemplary asset eligibility determination sub-process which is adapted to be used in any of the embodiments of the present invention. Each position of a potential investment is analyzed by loop 301. The system next proceeds through steps 311-319 to attempt to identify the type of the potential investment.

In step 311, the system determines whether the potential investment is a United States debt obligation. In step 312, the system determines whether the potential investment is a debt obligation backed by the full faith and credit of the United States. In step 313, the system determines whether the potential investment is a debt obligation issued by a U.S. department or agency. In step 314, the system determines whether the potential investment is a debt obligation of a state or political subdivision. In step 315, the system determines whether the potential investment is a debt obligation specifically authorized in 12 U.S.C. 24 (Seventh). If the potential investment is identified in steps 311-315, the system then proceeds to step 321 and determines whether the potential investment meets the Type I criteria established in 12 U.S.C. 24 (Seventh). If so, then the system proceeds to step 324a and enters that the investment is eligible. Otherwise, the system proceeds to step 325a and enters that the investment is ineligible.

If the system has not identified the potential investment in steps 311-315, it proceeds to steps 316-318. In step 316, the system determines whether the potential investment is a government debt obligation for housing, university or dormitory purposes. In step 317, the system determines whether the potential investment is one authorized by 12 U.S.C. 24 (Seventh) not to exceed 10% of the total capital invested per debt obligor. In step 318, the system determines whether the potential investment is a debt obligation issued by an international or multi-lateral development bank or organization. If the potential investment is identified in steps 316-318, the system then proceeds to step 322 and determines whether the potential investment meets the Type II criteria established in 12 U.S.C. 24 (Seventh). If so, then the system proceeds to step 324a and enters that the investment is eligible. Otherwise, the system proceeds to step 325a and enters that the investment is ineligible.

If the system has not identified the potential investment in steps 316-318, it proceeds to steps 319. In step 319, the system determines whether the potential investment is an investment security. The system then proceeds to step 323 and determines whether the potential investment meets the Type III criteria established in 12 U.S.C. 24 (Seventh). If so, then the system proceeds to step 324b and enters that the investment is eligible. Otherwise, the system proceeds to step 325b and enters that the investment is ineligible.

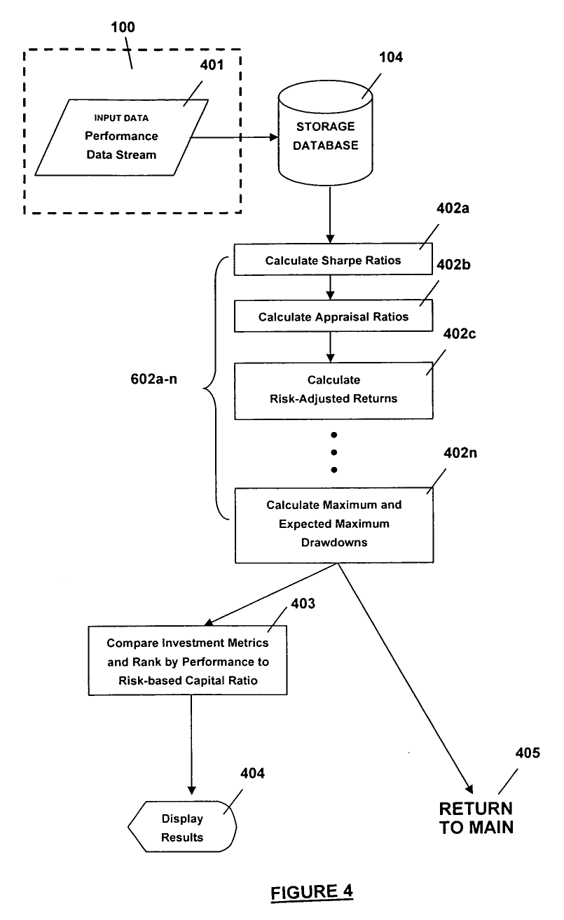

FIG. 4 depicts an exemplary monitoring process that can be optionally embodied in asset monitoring means 107. Means 107 can be any conventionally known device such as a computer, logic unit, network, PDA or appropriate software routine or engine known in the art. The system can receive a real-time performance data stream through unit 401 and input process 100. Such data is stored in database 104. The sub-process further calculates various investment metrics such as Sharpe (402a) and appraisal (402b) ratios, historical risk-adjusted returns (402c), and maximum/expected maximum drawdowns (402n). Other metrics not mentioned in the present application but known in the field can also be implemented. The sub-process is also adapted to perform stress testing on potential investments by using various data sets to analyze theoretical performance in potential market conditions. Such stress testing would include running scenarios to determine market fluctuation affect on the portfolio, e.g. interest rate or currency level fluctuation. Once calculation steps 402(a-n) are complete, the sub-process performs two functions. First, it sorts the data by user-specified criteria and presents the data on a display unit 604, and second, it returns the calculations from steps 402a-n to a return step 405. The process can additionally provide through display unit 404 an overview of the health of investments relative to historical data and less diversified bank-eligible investments with similar risk-based numbers. Further the system is adapted to review all the trades made by the investment management decision engines and identify undesirable risk characteristics present and instruct the investment management decision engines to correct these deficiencies in subsequent trades. Instead of the exemplary process described above, asset monitoring unit 107 may also use commercially-available software such as BEAR Measurisk™ to perform risk-analysis. Such commercially-available software can provide increased risk transparency and risk measurement solutions.

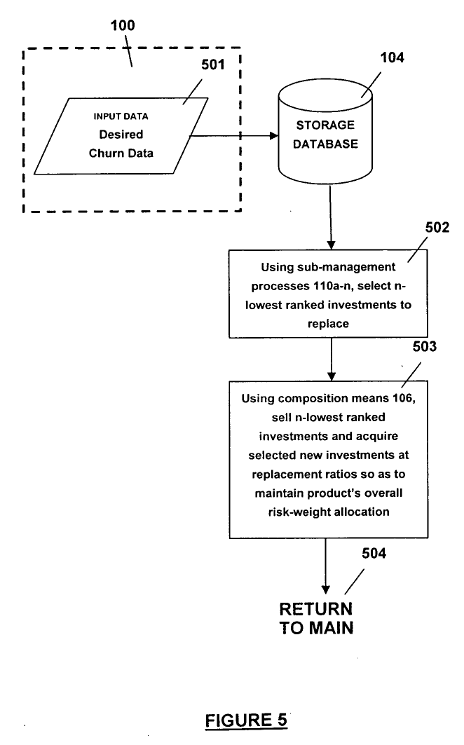

FIG. 5 depicts another exemplary process adapted to be used in any of the embodiments of the present invention as a part of asset monitoring unit 107. This process monitors data from database 104 (investment returns) relative to the risk-based capital category and periodically substitutes other investments with similar risk-based capital constraints based on chum data collected by input process 100 through unit 501. Asset monitoring unit 107 is adapted to selects the n-lowest ranked (by input criteria) investments to replace. In step 502, using decision engines 110a-n, the system selects new bank-eligible investments to replace positions in the n-lowest ranked investments. In step 503, using composition unit 106, the system sells the identified low positions and acquires positions in the new investments at replacement ratios so as to maintain the bank eligible investment product's overall risk-weight allocation. The process illustrated can be implemented in a device, such as a computer, logic unit, network, PDA or appropriate software routine or engine known in the art.

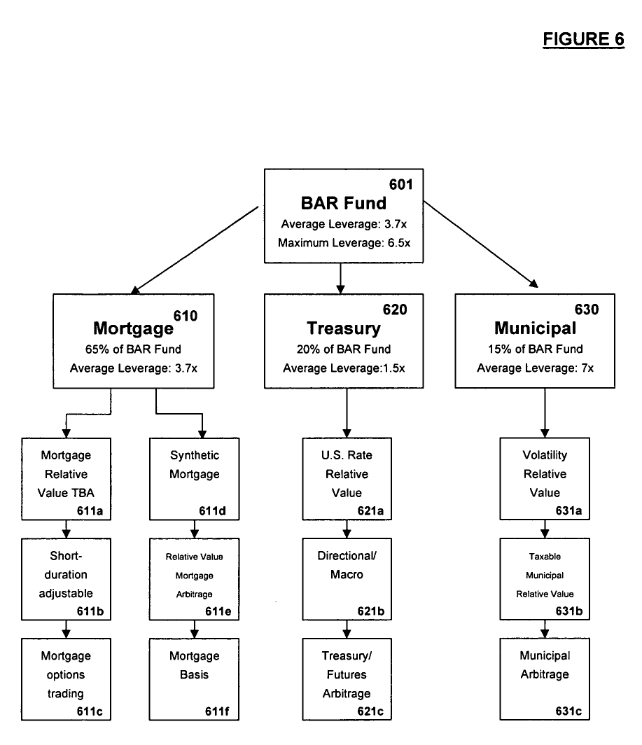

FIG. 6 depicts an exemplary composition of an investment product asset portfolio created by the first embodiment of the present invention. In this example, the entire portfolio 601 is composed of three types of assets, mortgage-backed securities 610, treasury instruments 620, and municipal instruments 630. Each of the type of assets 610, 620, and 630 can optionally be composed of a plurality of differing types of assets chosen by various strategies. Some exemplary strategies include, for mortgage-backed securities, mortgage relative value TBA 611a, short-duration adjustable 611b, mortgage options 611c, synthetic mortgage 611d, relative value arbitrage 611e, and mortgage basis 611f. For treasury instruments, exemplary strategies include U.S. rate relative value arbitrage 621a, directional/macro 621b, and futures arbitrage 621c. For municipal instruments, exemplary strategies include volatility relative value 631a, taxable municipal relative value 631b, and municipal arbitrage 631c. Each of 611a-f, 621a-c, and 631a-c represent a plurality of bank-eligible investments comprising a segment of a portfolio assembled by the present invention. Each of the pluralities is assembled by one of the exemplary investment management decision engines described herein.

Additional functions of the asset monitoring unit 107 depicted as steps 402a-n in FIG. 4 include risk control constraints by evaluating historical performance data of, e.g., the universe of bank-eligible investments; bank-eligible investments of a particular type or risk category; related bank-eligible investments (such as investments operated by the same investment company or fund); and the target investment by:

Identifying desired risk-based capital factor for the investment product as a whole and of each of the individual subpart investments;

Identifying which submarkets produce the greatest returns relative to other investments with the same risk-based category classification; or

Identifying the composition of each potential individual investment at current and historical averages in investment value.

Another embodiment of the claimed invention is a system that can create individual funds managed for clients. Such an embodiment would use the same structure depicted in FIGS. 1 and 7, producing exemplary portfolios as depicted in FIG. 6. The target client supplies a desired risk-based capital value and an investment amount, and the system creates a bank-eligible investment product accordingly. The system may also retrieve preference data through input process 100 and use preference weighting to assign client capital to particular assets.

Yet another embodiment of the claimed invention involves a structure similar to that described in the first embodiment further including user input into input means 103 of risk-based constraints as semi-fluid ranges adjusted by the claimed invention and comparison of, e.g., the 15-day, 30-day, 60-day, and 120-day moving averages of risk-based capital values of the subparts of the individual investments and adjusting constraints of the individual investments to match trending in the overall investment strategy at a periodic interval.

The present invention is also capable of being adapted for use in a bank-owned life insurance (BOLI) context.

The above description and drawings should only be considered illustrative of exemplary embodiments that achieve the features and advantages of the invention. Modification and substitutions to specific process conditions and structures can be made without departing from the spirit and scope of the invention. Accordingly, the invention is not to be considered as being limited by the foregoing description and drawings, but is only limited by the scope of the appended claims.

What is claimed as new and desired to be protected by Letters Patent of the United States is:

1. A system for managing a bank-eligible investment product comprising:
a first input unit for inputting data corresponding to a universe of bank-eligible investments;
a second input unit for inputting performance and risk-weighting data corresponding to the bank-eligible investments input to the first input unit;
a third input unit for inputting a desired risk-weighting ratio;
at least one investment management decision engine adapted to select a plurality of investments from the universe of bank-eligible investments;
a portfolio composition unit adapted to acquiring the at least one plurality of investments selected by the at least one investment management decision engine; and
a database adapted to store the inputted data, investment data for the at least one plurality of investments selected by the at least one investment management decision engine, and transaction data from the portfolio composition unit

2. The system claimed in claim 1, wherein the first, second, and third input unit comprise a single input unit.

3. The system claimed in claim 1, wherein at least one of the investment management decision engines selects a plurality of investments comprised of a predetermined number of bank-eligible investments with the highest return relative to their risk-weight percentage

4. The system claimed in claim 1, wherein the third input unit is also for inputting data corresponding to a predetermined number of assets each investment management decision engine is adapted to select.

5. The system claimed in claim 4, wherein each of the at least one investment management decision engines selects a predetermined number of assets.

6. The system claimed in claim 1, wherein of the at least one investment management decision engines is constrained to select a plurality of investments that meet a predetermined risk-weight exposure.

7. The system claimed in claim 6, wherein the constraints are permitted to vary within set percentage ranges

8. The system claimed in claim 1 further comprising:
an investment monitoring unit adapted to compare the performance of each asset to related bank-eligible investments and sort the assets by performance

9. The system claimed in claim 8, wherein the investment monitoring unit is adapted to instruct the at least one investment management decisions engine to modify the composition of its corresponding selected plurality of investments to replace lower-performing investments in the portfolio with other bank-eligible investments.

10. The system claimed in claim 8 wherein the investment monitoring unit includes a display unit for user reporting.

11. The system claimed in claim 1, wherein each of the at least one investment management decision engines is further adapted to continuously modify the composition of its corresponding selected plurality of investments by instructing the portfolio composition unit to acquire or sell positions in one or more bank-eligible investments.

12. A bank-eligible investment product comprising:
a portfolio consisting of a predetermined number of pluralities of assets wherein each plurality of assets is selected by an investment management process adapted to select the plurality of assets from the universe of bank-eligible investments, wherein capital is allocated to each of the assets to preferably maintain a predetermined ratio of capital base to risk-weighted assets.

13. The bank-eligible investment product of claim 12, where the investment management processes are constrained by a maximum risk-based capital exposure.

14. The bank-eligible investment product of claim 13, where the investment management processes are further adapted to continuously modify the composition of its corresponding selected plurality of assets to maximize investment return.

15. A method for designing a bank-eligible investment product comprising:
receiving input data corresponding to a universe of bank-eligible investments;
forwarding at least a portion of said input data to a predetermined plurality of investment management decision engines, each adapted to select a plurality of assets from the universe of bank-eligible investments;
receiving identification data corresponding to the plurality of assets selected by the investment management decision engines; and
allocating capital to each of the selected assets.

16. The method of claim 15, further comprising the steps of:
receiving input data corresponding to a predetermined ratio of capital base to risk-weighted assets for each of the predetermined plurality of investment management decision engines; and
monitoring the allocation of capital to each of the selected assets such that the ratio of capital base to risk-weighted assets does not exceed the predetermined ratio of capital base to risk-weighted assets corresponding to each investment management decision engine.

17. The method of claim 16, wherein the monitoring step further includes:
instructing the investment management decision engines to replace a number of lower-performing assets with other bank-eligible investments with higher return relative to their risk category percentage.

18. The method of claim 15, further including the step of
reporting performance data for each asset including a statistical comparison between each asset and similar bank-eligible investments.

19. The method of claim 15, wherein the investment management decision engines are constrained to select a plurality of assets that meet a predetermined risk-weight exposure.

20. The method of claim 15, wherein the investment management decision engines are constrained to select a plurality of assets that do not exceed a predetermined maximum leverage.
